(19) United States
(12) Patent Application Publication
(10) Pub. No.: US 2012/0222763 A1
(43) Pub. Date: Sep. 6, 2012

(54) FAUCET VALVE

(76) Inventor: Tsai-Chen YANG, Taichung City (TW)

(21) Appl. No.: 13/038,759

(22) Filed: Mar. 2, 2011

(51) Int. Cl. F16K 11/02

(52) U.S. Cl. 137/625.4

(57) ABSTRACT

A faucet valve of the present invention includes a pressure valve and a mix valve. The faucet valve can be connected to two external water pipes. The pressure valve can balance the water amount from the water pipes when the water pressure of the water pipes changes. The mix valve can mix the water from the water pipes and then output the water. Thereby, the present invention can stabilize the water temperature by balancing the amount of the hot water and the cold water.

### BACKGROUND OF THE INVENTION

1. Field of the Invention

The present invention relates to a faucet, and more particularly to a valve which is installed in a faucet for controlling the mix of hot water and cold water.

2. Description of the Prior Art

To avoid water being output with unstable temperature by the pressure changes of the hot and cold water sources, conventional faucets are installed with a movable valve to make a cold and hot water pipe respectively pass through two ends of the valve. The pressure will push the valve to move so as to change the diameter of the cold and hot water pipe, when the pressure of the cold and hot water pipe changes. Thereby, the flow amount of the cold and hot water pipe will be kept in balance as shown in TW 493712.

However, said valve is connected into the cold and hot water pipe, so users need to prevent leakage therefrom and to position other components while installing said valve. In other words, it is complicated to install said valve to a faucet. Therefore, the present invention is arisen to obviate or at least mitigate the above mentioned disadvantages.

### SUMMARY OF THE INVENTION

The main object of the present invention is to provide a faucet valve, which can balance the mix of the cold and hot water flow, and the faucet valve can be installed easily.

To achieve the above and other objects, a faucet valve of the present invention includes a shell, a bottom cover, a pressure valve, a mix valve and a control head.

The shell has a side wall and a partition. The side wall is disposed around the partition. The side wall and the partition define a first room. The partition is formed with a groove. The partition separates the groove and the first room. The partition is formed with a first opening and a second opening. The first opening and the second opening respectively communicate the first room with the groove. The shell further comprises an outlet which communicates with the first room.

The bottom cover is fixed to the shell and is formed with a recess. The recess and the groove are joined to form as a second room. The bottom cover is formed with a first flow hole and a second flow hole. The first flow hole and the second flow hole respectively communicate the second room with an external space.

The pressure valve is received in the second room so as to separate the first flow hole and the second flow hole. The first flow hole and the first opening define a first channel for water from outside flowing through the first channel and then entering into the first room. The second flow hole and the second opening define a second channel for water flowing from outside through the second channel and then entering into the first room. The pressure valve has a valve tube which is movable by a water pressure, so that the size of the first channel and the second channel is adjustable.

The mix valve is received in the first room. The mix valve makes water flow into the first room form the first opening and the second opening, and then be output to the outlet.

The control head is connected to the mix valve so as to control the amount of water flowing into the first room respectively from the first opening and the second opening.

Thereby, above-mentioned components can be assembled as the faucet valve which can be connected to an external hot and cold water source, and can also be connected to an external outlet with its outlet. The faucet valve is easy to be assembled in one time and can balance the cold and hot water flow amount with the pressure valve.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a preferred embodiment of the present invention;

FIG. 2 is a partial exploded drawing showing a preferred embodiment of the present invention;

FIG. 3 is an exploded drawing showing a preferred embodiment of the present invention;

FIG. 3A is a stereogram showing the shell of a preferred embodiment of the present invention in another viewing angle;

FIG. 3B is a plain-view drawing showing the shell of a preferred embodiment of the present invention;

FIG. 4 is a sectional drawing showing a preferred embodiment of the present invention;

FIG. 5 is an exploded drawing showing another preferred embodiment of the present invention;

FIG. 5A is a perspective drawing showing another preferred embodiment of the present invention;

FIG. 6 is a sectional drawing showing another preferred embodiment of the present invention.

### DETAILED DESCRIPTION OF THE PREFERRED EMBODIMENTS

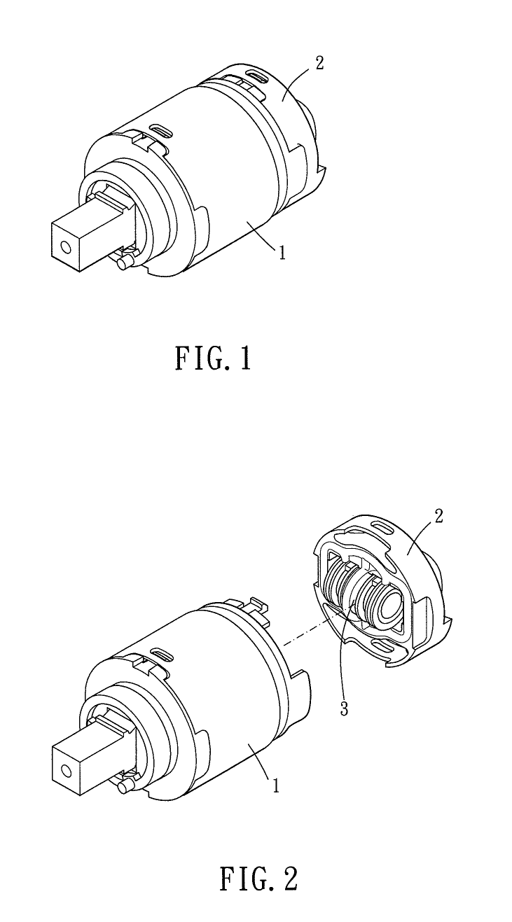

Please refer to FIGS. 1 to 4. The present invention provides a faucet valve includes a shell 1, a bottom cover 2, a pressure valve 3, a mix valve 4, and control head.

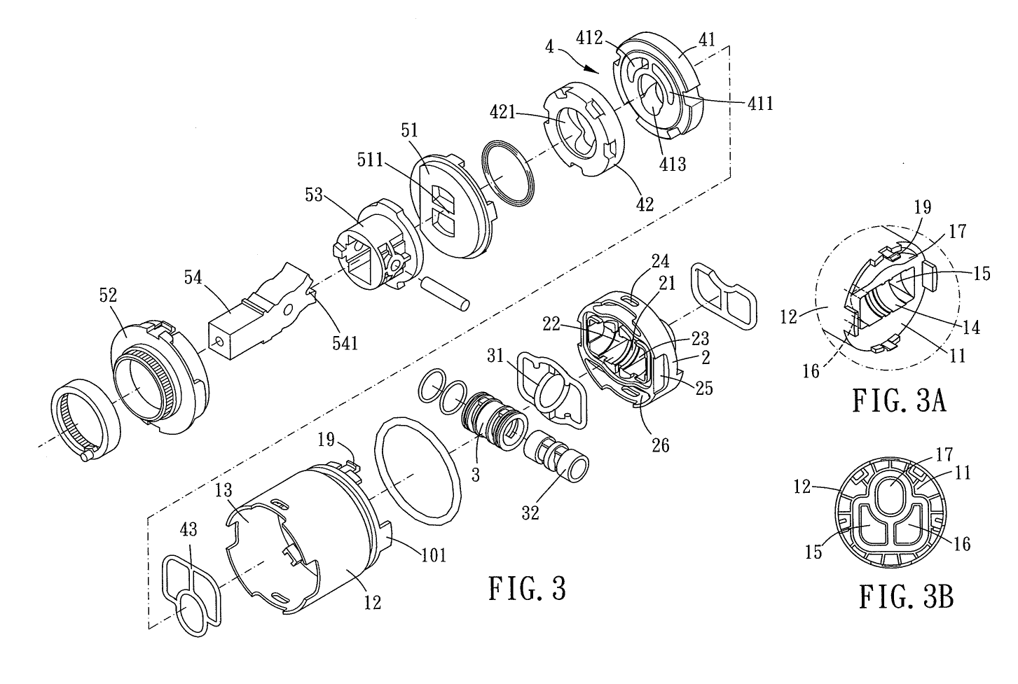

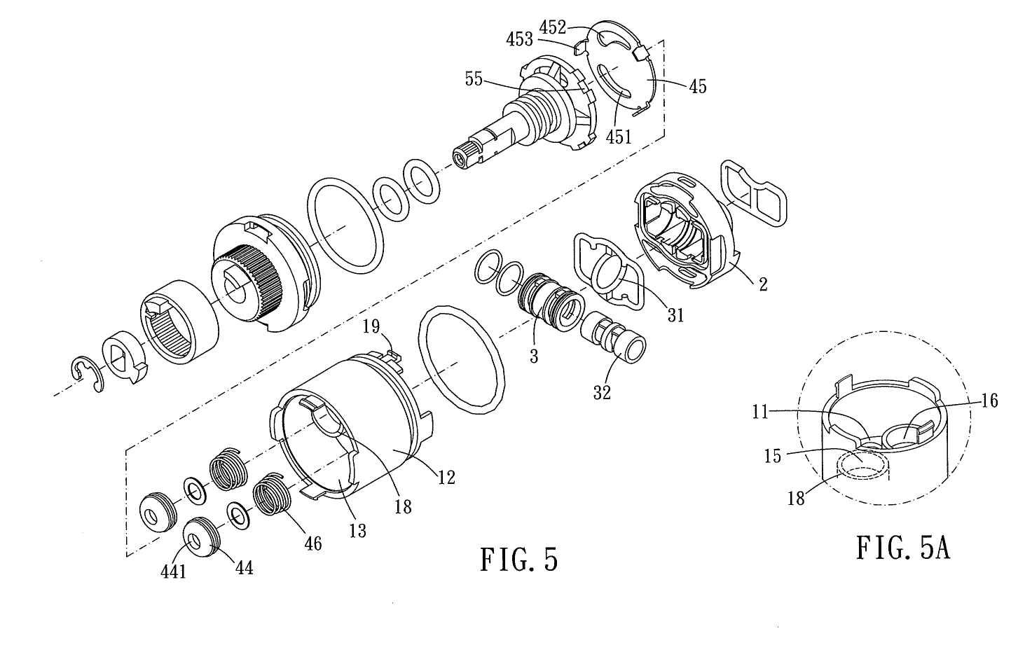

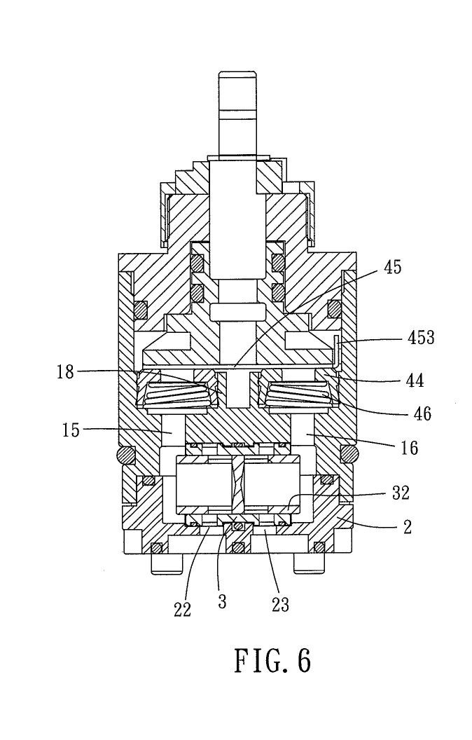

The shell 1 can be formed in one piece so as to be assembled with other components. Please refer to FIGS. 3A and 3B. The shell 1 has a partition 11 and a side wall 12 which is disposed around the partition 11. The side wall 12 and the partition 11 define a first room 13. The partition 11 is formed with a groove 14 which is located one side of the partition which is away from the first room 13, so that the partition 11 separates the groove 14 and the first room 13. The partition 11 is formed with a first opening 15 and a second opening 16. The first opening 15 and the second opening 16 respectively communicate the first room 13 with the groove 14. The shell 1 is further formed with an outlet 17 which communicates with the first room 13. Preferably, the outlet 17 is located at one side of the partition 11. In another preferred embodiment of the present invention, as shown in FIG. 5A and FIG. 6, the partition 11 is formed with tow ribs 18. Each rib 18 is convexly formed on the partition 11 and protrudes inside of the first room 13. The ribs 18 respectively encircle a periphery of the first opening 15 and the second opening 16, wherein the ribs 18 or the partition 11 can also be disposed with other convex ribs.

Please refer to FIGS. 1 to 4 again. The bottom cover is fixed to the shell 1, wherein the bottom cover is formed with a recess 21. The recess 21 and the groove 14 are joined to form as a second room. The bottom cover 2 is formed with a first flow hole 22 and a second flow hole 23. The first flow hole 22 and the second flow hole 23 respectively communicate a second room with an external space. Preferably, the shell 1 is formed with two clasp portions 19, and the bottom cover 2 is correspondingly formed with two clasp holes 24. The clasp portions 19 snap-fit into the clasp hole 24 so as to join and fix the shell 1 to the bottom cover 2. On the contrary, the shell 1 can be formed with several clasp holes 24, and the bottom cover 2 is formed with several corresponding clasp portions 19. Preferably, the shell 1 can further comprise several tabs 101 which convexly and axially protrude from a periphery of the shell 1. The bottom cover 2 further comprises several corresponding positioning slots 25, and each tab 101 abuts against one of the positioning slots 25, so that the shell 1 and the bottom cover 2 can be fixed with each other. The bottom cover 2 is formed with an outlet channel which communicates with the outlets 17 so as to make water flow out through outlet 17 and the outlet channel 26.

The pressure valve 3 is received in the second room. The pressure valve 3 separates the first flow hole 22 from the second flow hole 23. The first flow hole 22 and the first opening 15 define a first channel for water from outside flowing through the first channel and then entering into the first room 13. The second flow hole 23 and the second opening define a second channel for water from outside flowing through the second channel and then entering into the first room 13. A spacer 31 can be disposed between the pressure valve 3, the partition 11 and the bottom cover 2 so as to prevent from water leakage. The pressure valve 3 has a movable valve tube 32. The center of the valve tube 32 is closed and its two ends respectively connect to the first channel and the second channel. As the water pressure changes in the two channels the valve tube 32 is pushed to shift by the water pressure so as to change the size of the two channels. More specifically, the valve tube 32 can change the size of the minimum cross section inside of the two channels.

The mix vale 4 is received in the first room 13. The mix valve 4 can make water flow into the first room 13 from the first opening 15 and the second opening 16, and then be output to the outlet 17 after mixing. More specifically, the mix valve 4 comprises a fixed valve plate 41 and a controlling valve plate 42. The fixed valve plate 41 is formed with a first via hole 411, a second via hole 412 and a third via hole 413. The fixed valve plate 41 is received in the first room 13 and abuts against the partition 11. Further, a water proof gasket 43 can be disposed between the fixed valve plate 41 and the partition 11. The first via hole 411 communicates with the first opening 15, so that water from outside will flow through the first channel and then enter in the first via hole 411 inside of the firs room 13. The second via hole 412 communicates with the second opening 16, so that another water from outside will flow through the second channel and then enter in the second via hole 412 inside of the first room. The third via hole 413 communicates with the outlet 17. The controlling valve plate 42 abuts against the fixed valve plate 41, so that the controlling valve plate 42 can slide with respect to the fixed valve plate 41. The controlling valve plate 42 and the fixed valve plate 41 can be made from ceramics, and their surfaces are processed, such as polishing, so as to make their surface slippery and delicate. Thereby, when the controlling valve plate 42 abuts against the fixed valve plate 41, water cannot leak between the controlling valve plate 42 and the fixed valve plate 41. The controlling valve plate 42 is formed with a mix hole 421 which communicates with the third via hole 413. The first via hole 411 and the second via hole 412 respectively and selectively communicate with the mix hole 421 when the controlling valve plate 42 moves with respect to the fixed valve plate 41.

The control head is connected to the mix valve 4 so as to control the amount of water flowing into the first room 13 respectively form the first opening 15 and the second opening 16. More specifically, the control head includes a fixing block 51, a lid 52, a swivel member 53 and a toggle member 54. The fixing block 51 engages with the controlling valve plate 42 so as to be in a link-up relationship. The fixing block 51 has a hook portion 511. The lid 52 is fixed to the shell 1. The swivel member 53 is rotatably disposed to the lid 52. The toggle member 54 is pivotally disposed to the swivel member 53. An engaging portion 541 is disposed on one end of the toggle member 54. The engaging portion 541 engages with the hook portion 511, so that the toggle member 54 can drive the fixing block 51 to move when it sways, and further drive the controlling valve plate 42 to move. Also, the swivel member 53 can rotate with respect to the lid 52, so that the toggle member 54 and the fixing block then rotate to drive the controlling valve plate 42.

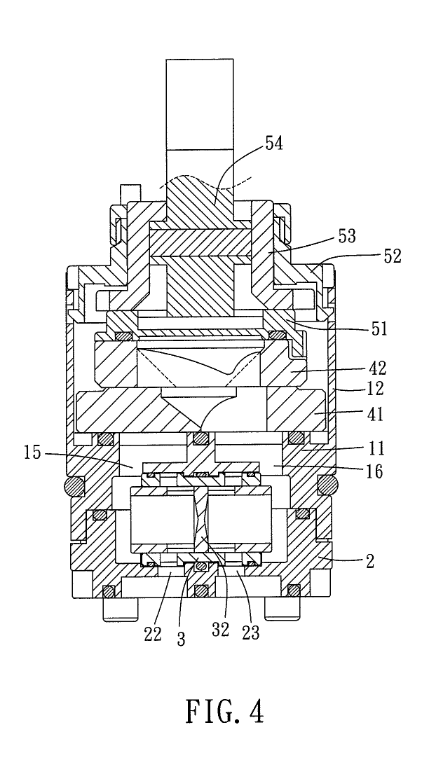

Please refer to FIG. 4. Consequently, two outside water sources can be respectively connected to the first channel and the second channel. The control head can drive the controlling valve plate 42 to rotate, and then the mix hole 421 respectively communicate with the first via hole 411 and the second via hole 412. Thereby, the water from the two outside water sources can converges into the first room 13 and flows out from the outlet 17. Otherwise, the controlling valve plate 42 can be driven to block or close the first via hole 411 or the second via hole 412, so that only one of the outside water sources can flow into the first room 13, and thereby the mix percentage of the two outside water sources can be controlled.

Please refer to FIG. 5 and FIG. 6. In another preferred embodiment of the present invention, the mix valve 4 includes two seal rings 44, a controlling valve plate 45, and two elastic members 46. Each seal ring 44 is formed with a through hole 441. Each seal ring 44 abuts against the partition 11, so that one of the through hole 441 communicates with the first opening 15, and the other through hole communicates with the second opening 16. Please refer to FIG. 5A. To be specifically, the seal rings respectively abut against the ribs 18, so that each rib 18 encircles the periphery of the seal rings 44 so as to prevent the water leakage. The controlling valve plate 45 is formed with a first slot hole 451 and a second slot hole 452. The controlling valve plate 452 is received in the first room 13. The first slot hole 451 and the second slot hole 452 respectively communicates with the first room 13. The controlling valve plate 45 abuts against the seal rings 44. The elastic members 46 are respectively disposed between the seal rings 44 and the partition 11. Each elastic member 46 provides an elastic force to make each seal ring 44 closely abut against the controlling valve plate 45.

The control head and the controlling valve plate 45 are in a link-up relationship. More specifically, the controlling valve plate 45 can be disposed with several projections 453, and the control head is disposed with several notches 55. Each of the projections 453 abuts against one of notches 55, so that controlling valve plate 45 is fixed to the control head, and the control head can drive the controlling valve plate 45 to rotate. The control head can be rotatably disposed in the shell 1, so that the control head can drive the controlling valve 45 to rotate.

Accordingly, the present invention joins the pressure valve and the mix valve into the shell, so that users can install the faucet valve to a faucet in one time without further assembling or positioning other components. That is to say that, the faucet valve can be installed efficiently. Moreover, the seal rings respectively encircle and abut against the ribs which are disposed on the partition so as to avoid water leakage.

What is claimed is:

1. A faucet valve, comprising:
a shell, having a side wall and a partition, the side wall being disposed around the partition, the side wall and the partition defining a first room, the partition being formed with a groove, the partition separating the groove and the first room, the partition being formed with a first opening and a second opening, the first opening and the second opening respectively communicating the first room with the groove, the shell being formed with an outlet which communicates with the first room;
a bottom cover, being fixed to the shell, the bottom cover being formed with a recess, the recess and the groove being joined to form as a second room, the bottom cover being formed with a first flow hole and a second flow hole, the first flow hole and the second flow hole respectively communicating the second room with an external space;
a pressure valve, being received in the second room so as to separate the first flow hole and the second flow hole, the first flow hole and the first opening defining a first channel for water from outside flowing through the first channel and then entering into the first room, the second flow hole and the second opening defining a second channel for water from outside flowing through the second channel and then entering into the first room, the pressure valve having a valve tube which is movable by a water pressure, so that the size of the first channel and the second channel is adjustable;
a mix valve, being received in the first room, the mix valve making water flow into the first room from the first opening and the second opening, and then be output to the outlet;
a control head, being connected to the mix valve so as to control the amount of water flowing into the first room respectively from the first opening and the second opening.

2. The faucet valve of claim 1, wherein the mix valve comprises two seal rings and a controlling valve plate, the seal rings are received in the first room, the seal rings respectively abut against the partition, the seal rings are respectively formed with a through hole, the through holes respectively communicate with the first opening and the second opening, the controlling valve plate abuts against the seal rings, the controlling valve plate is formed with a first slot hole and a second slot hole, the first slot hole and the second slot hole respectively communicate with the first room, the control head and the controlling valve plate are in a linking-up relationship, so that the control head can drive the controlling valve plate to rotate and make the first slot hole and the second slot hole respectively and selectively communicate with the through holes.

3. The faucet valve of claim 2, wherein the partition is formed with two ribs, the ribs respectively encircle and abut against a periphery of the seal rings.

4. The faucet valve of claim 1, wherein the mix valve comprises a fixed valve plate and a controlling valve plate, the fixed valve plate is formed with a first via hole, a second via hole and a third via hole, the fixed valve plate is received in the first room, the first via hole communicates with the first opening, the second via hole communicates with the second opening, the third via hole communicates with the outlet, the controlling valve plate is formed with a mix hole, the controlling valve plate slidably abuts against the fixed valve plate, the mix hole selectively communicates with the first via hole, the mix hole selectively communicates with the second via hole, the mix hole communicates with the third via hole, the control head and the controlling valve plate are in a linking-up relationship, so that the control head can drive the controlling valve plate to slide with respect to the fixed valve plate.

5. The faucet valve of claim 1, wherein the bottom cover is formed with an outlet channel, the outlet channel communicates with the outlet so as to make water flow out from the outlet channel and the outlet.
